(19) United States
(12) Patent Application Publication
(10) Pub. No.: US 2019/0303920 A1
(43) Pub. Date: Oct. 3, 2019

(54) TRANSACTION PROCESS USING BLOCKCHAIN TOKEN SMART CONTRACTS

(71) Applicant: American Express Travel Related Services Company, Inc., New York, NY (US)

(72) Inventors: Balaji Balaraman, Bangalore (IN); Andras L. Ferenczi, Peoria, AZ (US); Dallas L. Gale, Scottsdale, AZ (US); Nilesh Y. Jadhav, Phoenix, AZ (US); Harish R. Naik, Phoenix, AZ (US)

(73) Assignee: American Express Travel Related Services Company, Inc., New York, NY (US)

(21) Appl. No.: 15/943,168

(22) Filed: Apr. 2, 2018

(51) Int. Cl. G06Q 20/36; H04L 9/06; G06Q 20/40; H04L 29/08

(52) U.S. Cl. CPC G06Q 20/3674; H04L 9/0637; G06Q 20/389; H04L 67/1042; G06Q 20/4016

(57) ABSTRACT

A transaction system and process using a token smart contract is disclosed. The system may receive a transfer notification comprising a user public blockchain address, a merchant public blockchain address, and a transaction amount. The system may retrieve a transaction account identifier and a merchant identifier based on the user public blockchain address and the merchant public blockchain address. The system may adjust a transaction account balance associated with the user identifier based on the transaction amount. The system may credit a merchant account based on the transaction amount.

### FIELD

This disclosure generally relates to transaction authorizations, payments and similar processes, and more particularly, the disclosure relates to transaction processes using blockchain-based token smart contracts.

### BACKGROUND

Payment networks typically implement various systems for processing transactions between merchants and customers. Merchants are members of the payment network and the merchants may be authorized to charge to customer accounts. Customers have a transaction account with the payment network. To complete a transaction, a merchant typically transmits a payment request (or settlement) to the payment network with transaction details and the customer's account information. The payment network typically authorizes the payment request by assessing a transaction risk and debiting the transaction account.

### SUMMARY

A system, method, and computer readable medium (collectively, the “system”) for a transaction process using a token smart contract is disclosed. The system may receive a transfer notification comprising a user public blockchain address, a merchant public blockchain address, and a transaction amount. The system may retrieve a transaction account identifier and a merchant identifier based on the user public blockchain address and the merchant public blockchain address. The system may adjust a transaction account balance associated with the user identifier based on the transaction amount. The system may credit a merchant account based on the transaction amount.

The system may also invoke the token smart contract to finalize the transaction. The token smart contract may be invoked by passing the user public blockchain address, the merchant public blockchain address, and the transaction amount.

In various embodiments, in response to being invoked, the token smart contract may be configured to adjust a user token balance associated with a user blockchain wallet, based on the user public blockchain address and the transaction amount. The user public blockchain address corresponding to the user blockchain wallet may be associated with the transaction account identifier during a user registration process.

In various embodiments, in response to being invoked, the token smart contract may be configured to adjust a merchant token balance associated with a merchant blockchain wallet, based on the merchant public blockchain address and the transaction amount. The merchant public blockchain address corresponding to the merchant blockchain wallet may be associated with the merchant identifier during a merchant registration process.

In various embodiments, the token smart contract may comprise an ERC-20 compliant token.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. However, a more complete understanding of the present disclosure may be obtained by referring to the detailed description and claims when considered in connection with the drawing figures, wherein like numerals denote like elements.

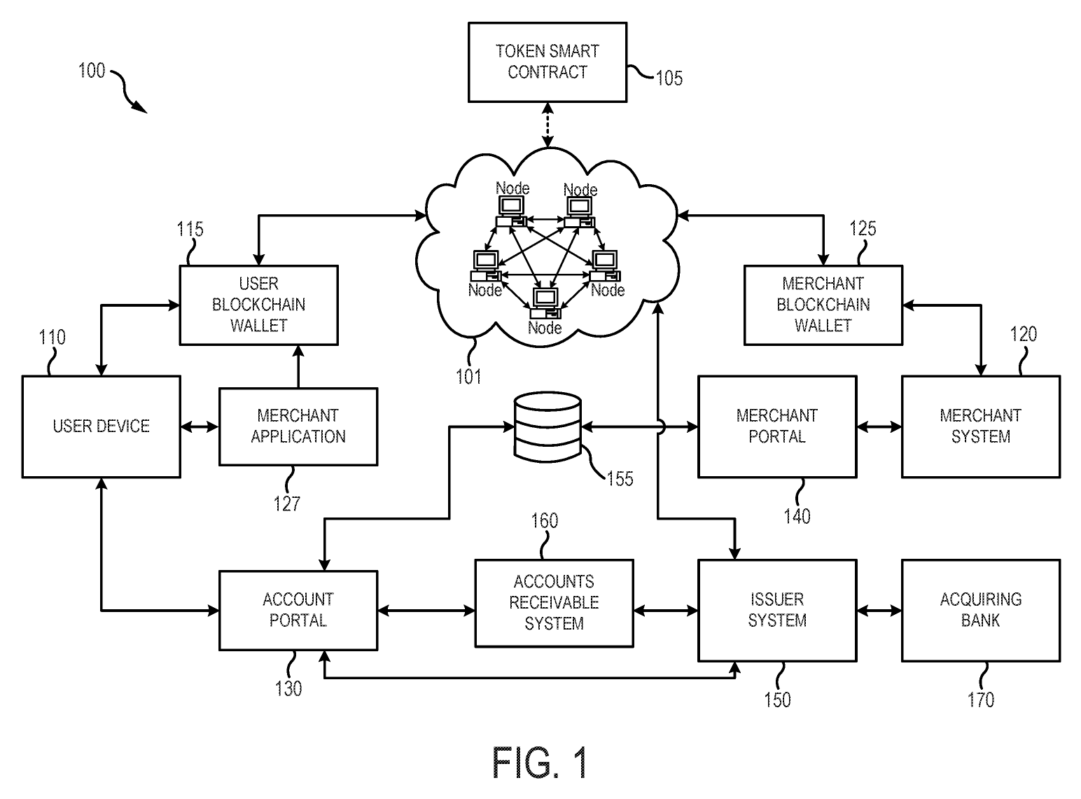

FIG. 1 is a block diagram illustrating a system for processing transactions using token smart contracts, in accordance with various embodiments;

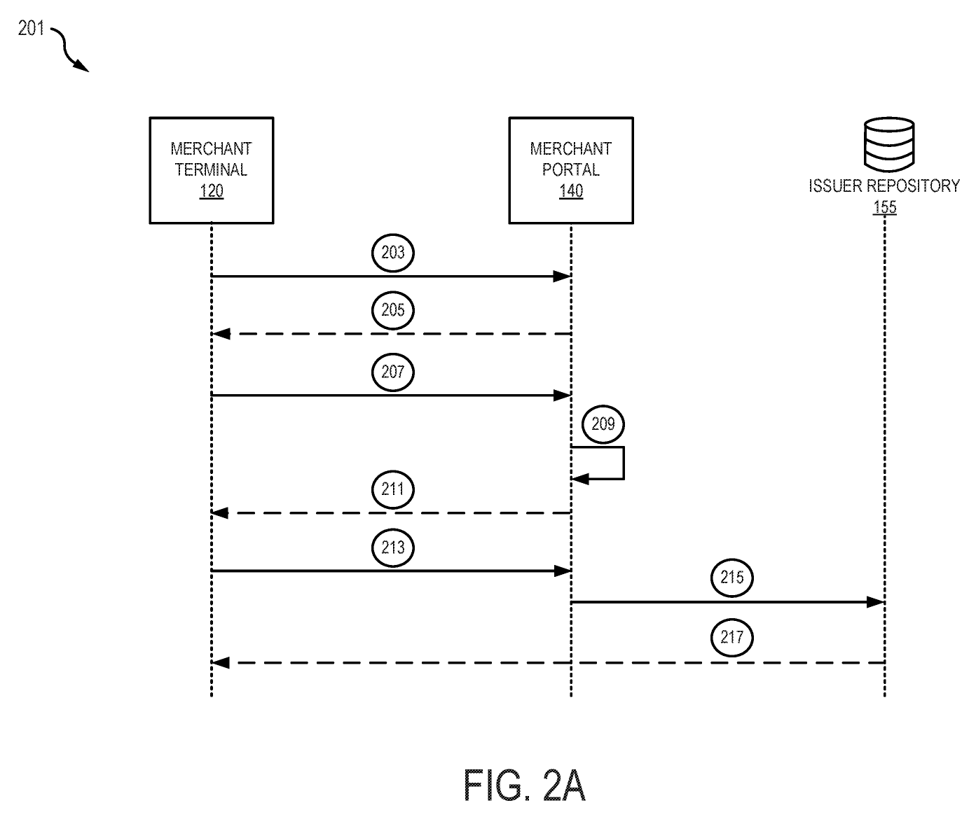

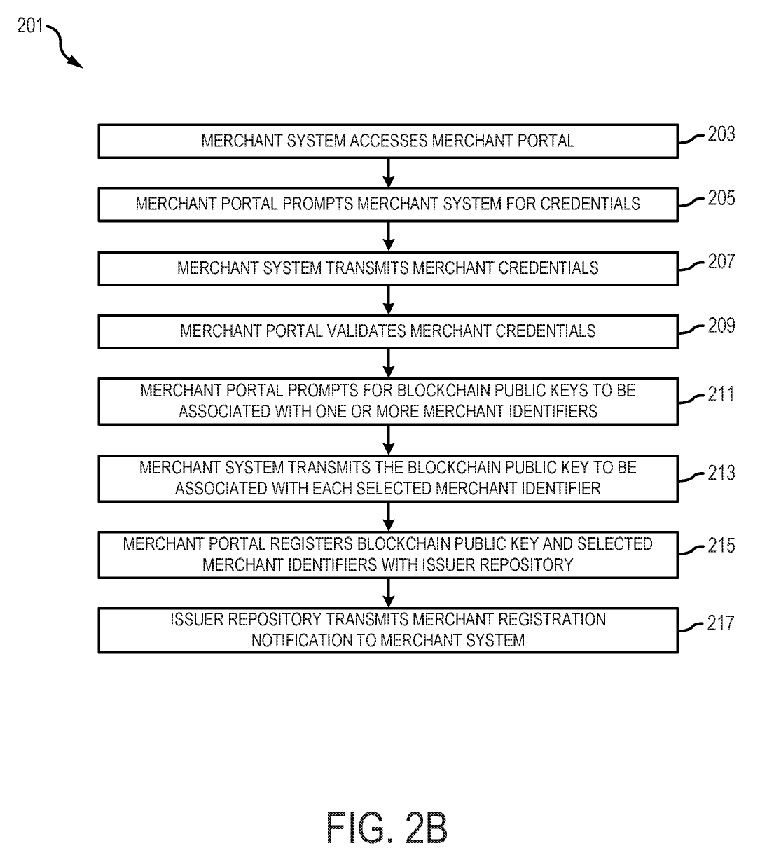

FIGS. 2A and 2B illustrate a process flow for merchant registration in a system for processing transactions using a token smart contract, in accordance with various embodiments;

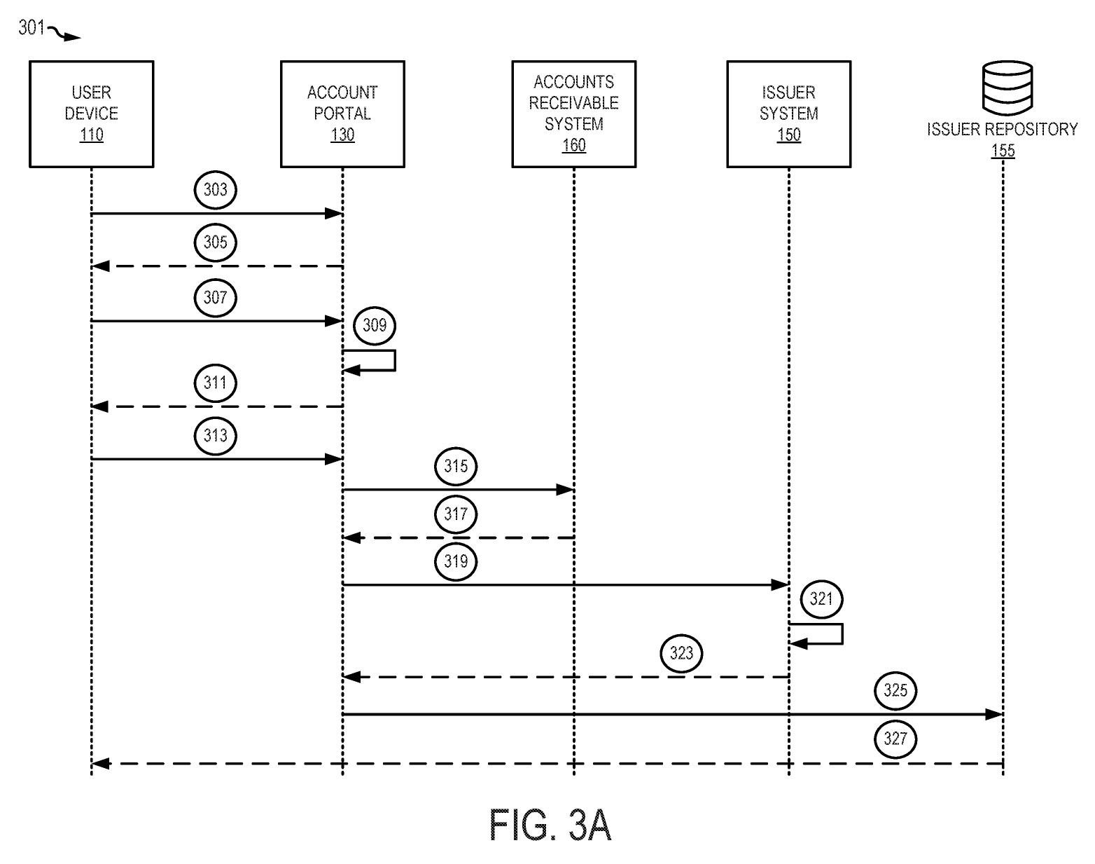

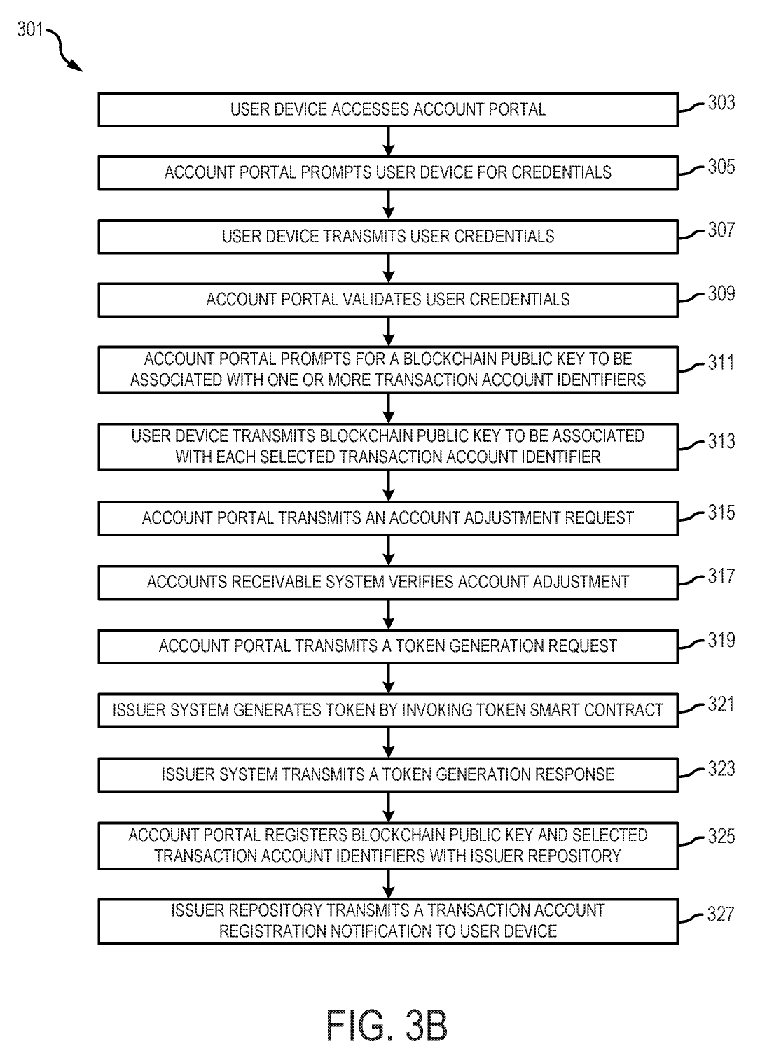

FIGS. 3A and 3B illustrate a process flow for user registration in a system for processing transactions using a token smart contract, in accordance with various embodiments; and

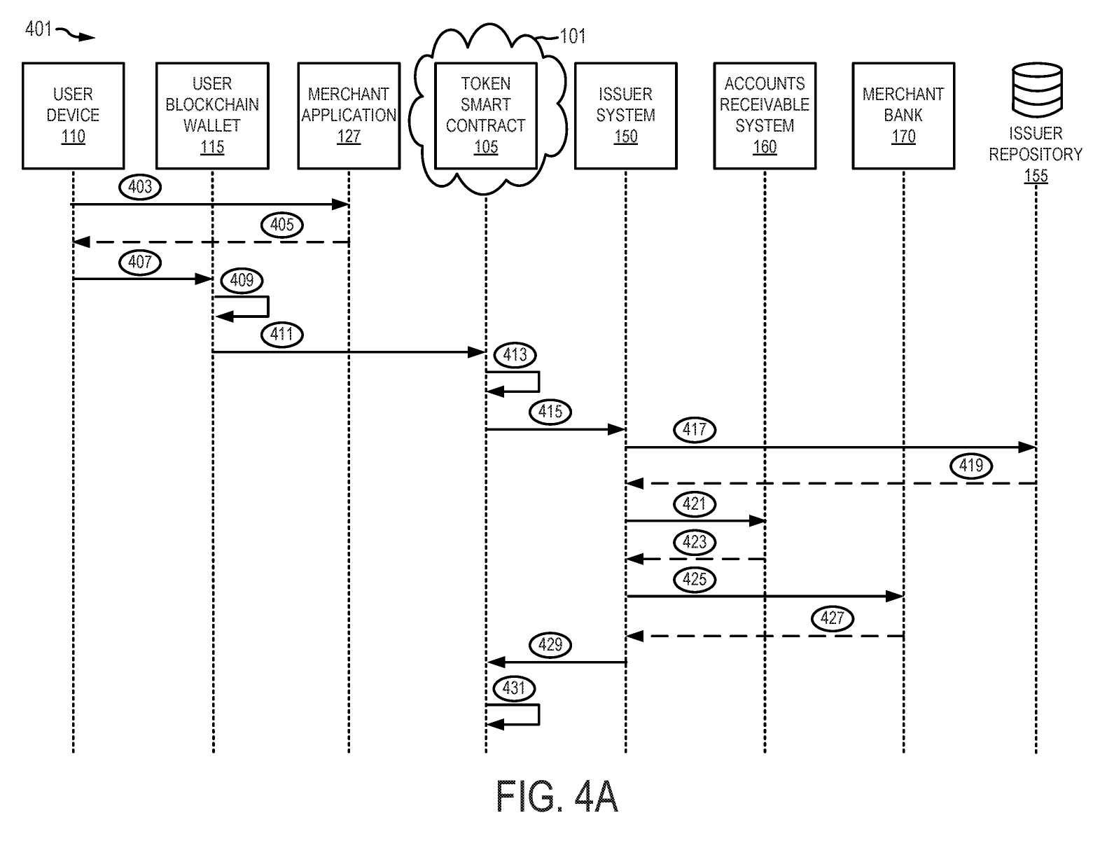

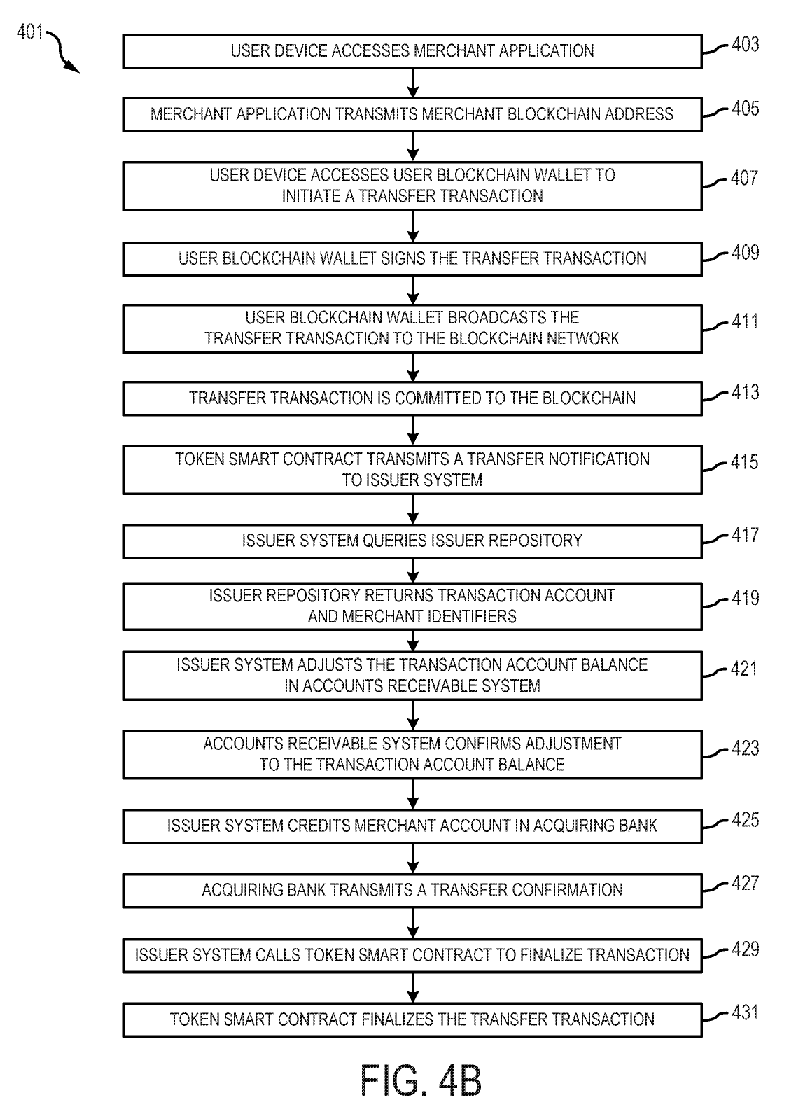

FIGS. 4A and 4B illustrate a transaction process in a system for processing transactions using a token smart contract, in accordance with various embodiments.

### DETAILED DESCRIPTION

The detailed description of various embodiments refers to the accompanying drawings, which show various embodiments by way of illustration. While these various embodiments are described in sufficient detail to enable those skilled in the art to practice the disclosure, it should be understood that other embodiments may be realized and that logical and physical changes may be made without departing from the spirit and scope of the disclosure. Thus, the detailed description is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Typical transactions involve an interaction between a buyer (e.g., customer, user, consumer, etc.) and a seller (e.g., service establishment, service provider, merchant, etc.). To complete a transaction, a merchant typically transmits a payment request (or settlement) to the payment network with transaction details and the consumer's account information. Systems and methods are disclosed to enable buyers and sellers to complete a secure transaction by means of a public or private blockchain. As discussed further herein, the system may facilitate the use of token smart contracts that record the transactions on an immutable ledger and smart contracts that facilitate workflow. The system may simplify integration of merchants into a payment network in comparison to conventional processes.

The system may employ or interact with a traditional account payment network to facilitate purchases and payments, authorize transactions, and settle transactions. For example, the traditional account payment network may represent existing proprietary networks that presently accommodate transactions for credit cards, debit cards, and/or other types of transactional instruments. The traditional account payment network may comprise an exemplary transaction network such as American Express®, VisaNet®, Mastercard®, Discover®, Interac®, Cartes Bancaires, JCB®, private networks (e.g., department store networks), and/or any other payment network.

The systems, methods, and computer readable mediums (collectively, the “system”) described herein, in accordance with various embodiments, may use a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

The system may integrate smart contracts that enforce business workflows in a decentralized manner. Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a Hyperledger® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network. For more information on distributed ledgers implementing features and functionalities of blockchain, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, U.S. application Ser. No. 15/728,086 titled SYSTEMS AND METHODS FOR LOYALTY POINT DISTRIBUTION and filed Oct. 9, 2017, U.S. application Ser. No. 15/785,843 titled MESSAGING BALANCING AND CONTROL ON BLOCKCHAIN and filed on Oct. 17, 2017, U.S. application Ser. No. 15/785,870 titled API REQUEST AND RESPONSE BALANCING AND CONTROL ON BLOCKCHAIN and filed on Oct. 17, 2017, U.S. application Ser. No. 15/824,450 titled SINGLE SIGN-ON SOLUTION USING BLOCKCHAIN and filed on Nov. 28, 2017, and U.S. application Ser. No. 15/824,513 titled TRANSACTION AUTHORIZATION PROCESS USING BLOCKCHAIN and filed on Nov. 28, 2017, the contents of which are each incorporated by reference in its entirety.

With reference to FIG. 1, a system 100 for processing transactions using token smart contracts is depicted, in accordance with various embodiments. System 100 may include various computing devices, software modules, networks, and data structures in communication with one another. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing. System 100 based on a blockchain, as described herein, may simplify and automate the transaction process by using the blockchain as a distributed and tamper-proof data store. Transparency is very high for various embodiments using a federated or public blockchain since validation is performed, for example, using data stored by a decentralized autonomous organization (DAO) instead of a specific financial institution.

System 100 may comprise a blockchain network 101 that operates on a blockchain, in accordance with various embodiments. Blockchain network 101 may be a distributed database that maintains records in a readable manner and that is resistant to tampering. Blockchain network 101 may be based on one or more blockchain technologies such as, for example, Ethereum, Open Chain, Chain Open Standard, Hyperledger Fabric, Corda, etc. The blockchain may comprise a system of blocks containing data that are interconnected by reference to the previous block. The blocks can hold various transaction data and/or other information as desired. Each block may link to the previous block and may include a timestamp. Data can be added to the blockchain by establishing consensus between the blockchain nodes based on proof of work, proof of stake, practical byzantine fault tolerance, delegated proof of stake, or other suitable consensus algorithms. When implemented in support of system 100, the blockchain may serve as an immutable log for transactions and related processes. Blockchain network 101 may be a peer-to-peer network that is private, federated and/or public in nature (e.g., Ethereum, Bitcoin, etc.). Federated and private networks may offer improved control over the content of the blockchain and public networks may leverage the cumulative computing power of the network to improve security. In that regard, blockchain network 101 may be implemented using technologies such as, for example, Ethereum GETH, eth-lightwallet, or other suitable or future blockchain interface technologies.

In various embodiments, blockchain network 101 may comprise one or more blockchain nodes (e.g., consensus participants) configured to maintain the blockchain. Each blockchain node may comprise a computing device configured to validate blocks of the blockchain. The computing devices may take the form of a computer or processor, or a set of computers and/or processors or application specific integrated circuits (ASICs), although other types of computing units or systems may also be used. Exemplary computing devices include servers, pooled servers, laptops, notebooks, hand held computers, personal digital assistants, cellular phones, smart phones (e.g., iPhone®, BlackBerry®, Android®, etc.) tablets, wearables (e.g., smart watches and smart glasses), Internet of things (IOT) devices or any other device capable of receiving data over network. Each computing device may run applications to interact with blockchain network 101, communicate with other devices, perform crypto operations, and otherwise operate within system 100. Computing devices may run a client application that can be a thin client (web) based, hybrid (i.e. web and native, such as iOS and Android), or native application to make API calls to interact with the blockchain.

In various embodiments, blockchain network 101 may use a Hierarchical Deterministic (HD) solution and may use BIP32, BIP39, and/or BIP44, for example, to generate an HD tree of public addresses. System 100 may include various computing devices configured to interact with blockchain network 101 either via a blockchain client, such as GETH, or via API calls using a blockchain as a service provider, such as MICROSOFT AZURE® or Blockapps STRATO, for example. The various computing devices of system 100 may be configured to store transaction data and execute smart contracts using blockchain network 101 for data storage and/or validation. The smart contracts may be completed by digital signature using asymmetric crypto operations and a private key, for example, and as discussed further herein.

In various embodiments, blockchain network 101 may host a token smart contract 105 that controls the end-to-end flow of the system and autonomously governs the transaction process by supporting execution and recording of the transaction data. Token smart contract 105 may be configured to store and maintain merchant and cardholder account balances, as discussed further herein. Token smart contract 105 may be an executable that writes data to the blockchain in a predetermined format based on predetermined function parameters passed by an API call. Token smart contract 105 may include a program written in a programming language such as, for example, Solidity, or any other suitable programming language. Token smart contract 105 may comprise any suitable type of token or smart contract in accordance with any suitable standard, such as, for example, an ERC-20 compliant token.

In various embodiments, system 100 may comprise a user device 110. User device 110 may comprise any suitable combination of hardware and/or software and may be a computing device such as a server, laptop, notebook, hand held computer, personal digital assistant, cellular phone, smart phone (e.g., iPhone®, BlackBerry®, Android®, etc.) tablet, wearable (e.g., smart watches, smart glasses, smart rings, etc.), Internet of things (IoT) device, smart speaker, or any other similar device. User device 110 may comprise software configured to aid user device 110 in interacting with components of system 100. For example, user device 110 may comprise a user blockchain wallet 115.

User device 110 may be in electronic communication with blockchain network 101 via user blockchain wallet 115. User blockchain wallet 115 may comprise any suitable distributed-ledger based wallet that allows for the installation of smart contracts (e.g., token smart contract 105), such as, for example, Ethereum GETH, eth-lightwallet, and/or any other suitable blockchain interface technologies. User blockchain wallet 115 may serve as a blockchain interface accessible by applications installed on user device 110. For example, user blockchain wallet 115 may be configured to register user device 110 with the blockchain, write data to the blockchain according to token smart contract 105, write transaction data to the blockchain, and request public key (e.g., user blockchain address) and private key pairs from blockchain network 101, as discussed further herein. In various embodiments, user blockchain wallet 115 may comprise a blockchain node in blockchain network 101. In various embodiments, user blockchain wallet 115 may be located in a separate blockchain network and may be in electronic communication with blockchain network 101.

User device 110 may be in electronic and/or operative communication with a merchant application 127. Merchant application 127 may comprise software, a mobile application, a web interface, or the like accessible from user device 110. Merchant application 117 may allow a user, via user device 110, to browse, interact with, and purchase physical goods, digital goods, services, or the like from a merchant (e.g., merchant system 120). Merchant application 117 may be configured to allow a user, via user device 110, to transfer funds and/or pay for goods, services, or the like via user blockchain wallet 115, as discussed further herein. Merchant application 117 may be in electronic and/or operative communication with merchant system 120, and/or may be hosted on merchant system 120 and accessible via user device 110.

User device 110 may be in electronic and/or operative communication with an account portal 130. Account portal 130 may comprise software, a mobile application, a web interface, or the like accessible from user device 110. Account portal 130 may be in electronic communication with issuer repository 155 and/or accounts receivable system 160. Account portal 130 may further be in electronic and/or operative communication with issuer system 150, and/or may be hosted on issuer system 150 and accessible via user device 110. In that respect, account portal 130 may be configured to provide a user, via user device 110, access to transaction account information (e.g., account balances, transaction account numbers, billing addresses and information, etc.). Account portal 130 may be configured to allow the user, via user device 110, to select or input and associate one or more blockchain public addresses with a transaction account identifier (e.g., a transaction account number, a primary account number (PAN), etc.), as discussed further herein. Account portal 130 may also be configured to transmit token generation requests to issuer system 150 in response to associating one or more blockchain public addresses with the transaction account identifier, as discussed further herein.

Issuer repository 155 may be in electronic communication with account portal 130 and/or merchant portal 140, and may comprise any suitable data structure discussed herein. Issuer repository 155 may be configured to store and maintain registration information collected from user device 110 (via account portal 130) and/or merchant system 120 (via merchant portal 140). For example, issuer repository 155 may be configured to store mappings of one or more merchant public blockchain addresses associated with one or more merchant identifiers, as discussed further herein. Issuer repository 155 may also be configured to store mappings of one or more user public blockchain addresses associated with one or more transaction account identifiers, as discussed further herein.

In various embodiments, merchant system 120 may be configured to allow a merchant access to system 100. For example, a merchant may interact with merchant system 120 to associate one or more merchant blockchain addresses with one or more merchant identifiers, as discussed further herein. Merchant system 120 may comprise any suitable combination of hardware and/or software, and may comprise one or more of a server, computing device, data structure or the like. Merchant system 120 may be in electronic and/or operative communication with merchant blockchain wallet 125 and/or merchant portal 140.

Merchant system 120 may be in electronic communication with blockchain network 101 via merchant blockchain wallet 125. Merchant blockchain wallet 125 may comprise any suitable distributed-ledger based wallet that allows for the installation of smart contracts (e.g., token smart contract 105), such as, for example, Ethereum GETH, eth-lightwallet, and/or any other suitable blockchain interface technologies. Merchant blockchain wallet 125 may serve as a blockchain interface accessible by applications installed on merchant system 120. For example, merchant blockchain wallet 125 may be configured to register merchant system 120 with the blockchain, write data to the blockchain according to token smart contract 105, write transaction data to the blockchain, and request public key (e.g., merchant blockchain address) and private key pairs from blockchain network 101, as discussed further herein. In various embodiments, merchant blockchain wallet 125 may comprise a blockchain node in blockchain network 101. In various embodiments, merchant blockchain wallet 125 may be located in a separate blockchain network and may be in electronic communication with blockchain network 101.

Merchant system 120 may be in electronic and/or operative communication with a merchant portal 140. Merchant portal 140 may comprise software, a mobile application, a web interface, or the like accessible from merchant system 120. Merchant portal 140 may be in electronic communication with issuer repository 155. Merchant portal 140 may further be in electronic and/or operative communication with issuer system 150, and/or may be hosted on issuer system 150 and accessible via merchant system 120. Merchant portal 140 may be configured to allow a merchant, via merchant system 120, to associate one or more blockchain public addresses to one or more merchant identifiers (e.g., a merchant ID), as discussed further herein.

In various embodiments, issuer system 150 may be configured as a central hub to access various systems, engines, and components of a payment network, as discussed further herein. Issuer system 150 may comprise one or more of a server, computing device, data structure or the like, and may be in electronic and/or operative communication with blockchain network 101, accounts receivable system 160, and/or acquiring bank 170. The payment network, which may be part of certain transactions, represents existing proprietary networks that presently accommodate transactions for credit cards, debit cards, and/or other types of transactional instruments. Payment network may be a closed network that is secure from eavesdroppers. In various embodiments, payment network may comprise an exemplary transaction network such as American Express®, VisaNet®, Mastercard®, Discover®, Interac®, Cartes Bancaires, JCB®, private networks (e.g., department store networks), and/or any other payment network. Issuer system 150 may be configured to authorize and settle payment transactions; maintain and adjust transaction account member databases, accounts receivable databases, accounts payable databases, or the like; perform clearing and settlement of fiat currency funds with acquiring bank 170; and/or additional processing tasks as described further herein.

In various embodiments, accounts receivable system 160 may be configured to store and maintain transaction account balances and similar data, and may comprise any suitable data structure and/or software interface. Accounts receivable system 160 may be configured to adjust transaction account balances in response to receiving instructions from issuer system 150, as discussed further herein.

In various embodiments, acquiring bank 170 may comprise any suitable bank or financial institution that processes credit or debit card payments on behalf of a merchant and stores and maintains the merchant's bank account to receive payments. Acquiring bank 170 may receive payments and instructions from issuer system 150, as discussed further herein.

The various electronic communications of system 100 including the registration requests, transaction processes, writing to blockchain network 101, and/or reading data from blockchain network 101 may be accomplished using a network. As used herein, the term “network” includes any cloud, cloud computing system or electronic communications system or method that incorporates hardware and/or software components. Communication among the parties may be accomplished through any suitable communication channels, such as, for example, a telephone network, an extranet, an intranet, Internet, point of interaction device (point of sale device, personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, AppleTalk, IP-6, NetBIOS, OSI, any tunneling protocol (e.g., IPsec, SSH, etc.), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems. Asymmetric encryption in particular may be of use in signing and verifying signatures for blockchain crypto operations.

Referring now to FIGS. 2A-4B, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps depicted in FIGS. 2-4B, but also to the various system components as described above with reference to FIG. 1.

With specific reference to FIGS. 2A and 2B, and continued reference to FIG. 1, a merchant registration process 201 in a system for processing transactions using a token smart contract is shown, according to various embodiments. Merchant system 120 accesses merchant portal 140 (step 203). Merchant portal 140 prompts merchant system 120 for merchant credentials (step 205). For example, the merchant credentials may comprise a username (e.g., merchant identifier, etc.) and password, a biometric input, or the like. Merchant system 120 transmits the merchant credentials (step 207). For example, a merchant, user, staff, software or the like may input the merchant credentials and, upon confirming entry, merchant system 120 may transmit the merchant credentials to merchant portal 140. Merchant portal 140 validates the merchant credentials (step 209). Merchant portal 140 may validate the merchant credentials using any suitable technique. For example, merchant portal 140 may validate the merchant credentials by comparing the input against stored merchant credentials.

In various embodiments, merchant portal 140 prompts merchant system 120 for the blockchain public keys to be associated with one or more merchant identifiers (step 211). For example, merchant portal 140 may display, via merchant system 120, one or more merchant identifiers that can be associated with a blockchain wallet (e.g., merchant blockchain wallet 125). Each merchant may have one or more associated merchant identifiers (e.g., a first merchant ID, a second merchant ID, etc.). Merchant system 120 transmits the blockchain public key to be associated with each selected merchant identifier (step 213). For example, the merchant, user, staff, or the like may input or select the blockchain public key to be associated with each merchant identifier. In various embodiments, merchant system 120 may “preregister” with merchant blockchain wallet 125 to obtain a blockchain public key. Merchant blockchain wallet 125 may generate and/or receive an asymmetric key pair, including the private key (e.g., merchant private key) paired with the public key (e.g., merchant public key). The public key and the private key may be generated using any suitable technique, such as BIP32, BIP39, BIP44, or the like. The public key may comprise a blockchain address. Merchant blockchain wallet 125 may encrypt and store the private key during the “preregistration” process.

Merchant portal 140 registers the blockchain public keys and the selected merchant identifiers with issuer repository 155 (step 215). In response to receiving the blockchain public key and selected merchant identifiers from merchant system 120, merchant portal 140 may transmit the blockchain public key and selected merchant identifiers to issuer repository 155. Issuer repository 155 may store the blockchain public key and selected merchant identifiers using any suitable technique, such as, for example, ordered by each merchant identifier with the corresponding associated blockchain public key. In various embodiments, issuer repository 155 may also be configured to encrypt the data prior to storing the blockchain public key and selected merchant identifiers. Issuer repository 155 transmits a merchant registration notification to merchant system 120 (step 217). The merchant registration notification may comprise a “success,” “fail,” or similar identifier to notify merchant system 120 of whether the blockchain public key was successfully associated and/or stored with the selected merchant identifiers. For example, in response to a merchant identifier being previously associated and stored, the merchant registration notification may comprise data indicating that the selected merchant identifier was previously associated with a blockchain public address.

With specific reference to FIGS. 3A and 3B, and continued reference to FIG. 1, a user registration process 301 in a system for processing transactions using a token smart contract is shown, according to various embodiments. User device 110 accesses account portal 130 (step 303). Account portal 130 prompts user device 110 for user credentials (step 305). User device 110 transmits the user credentials (step 307). For example, a transaction account holder, user, or the like may input the user credentials, such as, for example, a username and password, a biometric input, or the like. Account portal 130 validates the user credentials (step 309). Account portal 130 may validate the user credentials using any suitable technique. For example, account portal 130 may validate the user credentials by comparing the input against stored user credentials.

In various embodiments, account portal 130 prompts for a blockchain public key to be associated with one or more transaction account identifiers (step 311). For example, account portal 130 may display, via user device 110, one or more transaction account identifiers that can be associated with a blockchain wallet (e.g., merchant blockchain wallet 125). Each transaction account identifier may comprise a transaction account number, primary account number (PAN), and/or any other suitable identifier. User device 110 transmits the blockchain public key to be associated with each selected transaction account identifier (step 313). For example, the user, transaction account holder, or the like may input or select the blockchain public key to be associated with each transaction account identifier. In various embodiments, user device 110 may “preregister” with user blockchain wallet 115 to obtain a blockchain public key. User blockchain wallet 115 may generate and/or receive an asymmetric key pair, including the private key (e.g., merchant private key) paired with the public key (e.g., merchant public key). The public key and the private key may be generated using any suitable technique, such as BIP32, BIP39, BIP44, or the like. The public key may comprise a blockchain address. User blockchain wallet 115 may encrypt and store the private key, during the “preregistration” process.

In various embodiments, account portal 130 transmits an account adjustment request (step 315). The account adjustment request may comprise the selected transaction account identifier and a token amount. For example, the user, transaction account holder, or the like may be prompted by account portal 130, via user device 110, to input the token amount and/or the transaction account to designate funds from. Account portal 130 may transmit the account adjustment request to accounts receivable system 160. In response to receiving the account adjustment request, accounts receivable system 160 may be configured to adjust the designated transaction account accordingly. For example, in response to the token amount being $100.00, accounts receivable system 160 may decrease the available balance in the transaction account by $100.00. In various embodiments, accounts receivable system 160 may also be configured to mark or display on the transaction account that $100.00 is the available token balance (e.g., a consumer accessing a transaction account may see that $100.00 has been purchased or set aside for a token). In various embodiments, wherein the transaction account is a credit card account, accounts receivable system 160 may be configured to adjust the available credit according to the token amount (e.g., an available credit of $5000.00 may be adjusted to an available credit of $4900.00). Accounts receivable system 160 verifies the account adjustment with account portal 130 (step 317).

In various embodiments, account portal 130 transmits a token generation request (step 319). The token generation request may comprise the blockchain public key and the token amount. Account portal 130 may transmit the token generation request to issuer system 150. Issuer system 150 generates a token by invoking token smart contract 105 (step 321). Issuer system 150 may invoke token smart contract 105 by passing the blockchain public key and the token amount. In response to being invoked, token smart contract 105 may generate a token comprising the blockchain public key and the token amount, and may write the token to the blockchain. In various embodiments, token smart contract 105 may comprise an internal mapping of public blockchain addresses to corresponding token balances. In that respect, as token balances are adjusted or added (as described further herein), token smart contract 105 may adjust or add to the internal mapping accordingly. Issuer system 150 transmits a token generation response (step 323). Issuer system 150 may generate the token generation response to comprise an indication of whether the token generation was successful (e.g., “success,” “fail,” etc.), and may transmit the token generation response to account portal 130. For example, in response to token smart contract 105 encountering an error writing the token to the blockchain, issuer system 150 may transmit a token generation response comprising data of the error.

In various embodiments, account portal 130 registers the blockchain public keys and the selected transaction account identifiers with issuer repository 155 (step 325). Issuer repository 155 may store the blockchain public key and selected transaction account identifiers using any suitable technique, such as, for example, ordered by each transaction account identifier with the corresponding associated blockchain public key. In various embodiments, issuer repository 155 may also be configured to encrypt the data prior to storing the blockchain public key and selected transaction account identifiers. Issuer repository 155 transmits a transaction account registration notification to user device 110 (step 327). The transaction account registration notification may comprise a “success,” “fail,” or similar identifier to notify user device 110 of whether the blockchain public key was successfully associated and/or stored with the selected transaction account identifiers. . For example, in response to a transaction account identifier being previously associated and stored, the transaction account registration notification may comprise data indicating that the selected transaction account identifier was previously associated with a blockchain public address.

With specific reference to FIGS. 4A and 4B, and continued reference to FIG. 1, a transaction process 401 in a system for processing transactions using a token smart contract is shown, according to various embodiments. User device 110 accesses merchant application 127 (step 403). User device 110 may browse merchant application 127 to purchase a good or service. User device 110 may initiate a transaction via merchant application 127 to purchase a good or service. Merchant application 127 transmits a merchant blockchain address (step 405). In response to user device 110 initiating the payment process, merchant application 127 may transmit the merchant blockchain address associated with the merchant. For example, merchant application 127 may be programmed or comprise dedicated embedded functionality to control the transmission of the merchant blockchain address to user device 110. User device 110 accesses user blockchain wallet 115 (e.g., via a web browser or the like) to initiate a transfer transaction (step 407). The transfer transaction may be initiated by invoking token smart contract 105. The transfer transaction may comprise the merchant blockchain address and the transaction amount to be transferred. User blockchain wallet 115 signs the transfer transaction using private key (step 409). User blockchain wallet 115 broadcasts the transfer transaction to blockchain network 101 (step 411). The transfer transaction is committed to the blockchain (step 413). The transfer transaction may be committed to the blockchain using any suitable blockchain specific consensus algorithm.

In various embodiments, in response to the transfer transaction being committed to the blockchain, token smart contract 105 transmits a transfer notification to issuer system 150 (step 415). The transfer notification may comprise the user public blockchain address, the merchant public blockchain address, and the transaction amount. Issuer system 150 queries issuer repository 155 (step 417). Issuer system may query issuer repository 155 to locate transaction account identifying information and merchant identifying information to process the transaction. For example, issuer system 150 may query issuer repository 155 based on the user public blockchain address to locate and retrieve associated transaction account identifying information. As a further example, issuer system 150 may query issuer repository 155 based on the merchant public blockchain address to locate and retrieve the associated merchant identifying information. Issuer repository 155 returns transaction account and merchant identifiers (step 419). Issuer system 150 adjusts the transaction account balance in accounts receivable system 160 (step 421). Issuer system 150 may instruct accounts receivable system 160 to adjust the transaction account corresponding to the user public blockchain address by the transaction amount. In various embodiments, wherein an available token balance is previously established (e.g., in step 315, with brief reference to FIGS. 3A and 3B), the available token balance may be adjusted based on the transaction amount. In various embodiments wherein the transaction account is a credit card, the outstanding balance may be increased based on the transaction amount. Accounts receivable system 160 confirms adjustment to transaction account balance with issuer system 150 (step 423).

In various embodiments, issuer system 150 credits merchant account in acquiring bank 170 (step 425). Issuer system 150 may credit the merchant account corresponding to the merchant public blockchain address based on the transaction amount. Acquiring bank 170 transmits a transfer confirmation to issuer system 150 (step 427). The transfer confirmation may comprise data indicating whether the credit was successful.

In various embodiments, issuer system 150 calls token smart contract 105 to finalize the transaction (step 429). Issuer system 150 may pass the user public blockchain address, the merchant public blockchain address, and the transaction amount to invoke token smart contract 105. For example, issuer system 150 may call token smart contract 105 in response to receiving the transfer confirmation from acquiring bank 170 (e.g., in step 427). Token smart contract 105 may adjust the token balance (e.g., the user token balance) associated with user blockchain wallet 115 to reflect the transaction amount paid by the transaction account holder. Token smart contract 105 may adjust the token balance (e.g., the merchant token balance) associated with merchant blockchain wallet 125 to reflect the transaction amount received by the merchant. Token smart contract 105 finalizes the transfer transaction (step 431). The transfer transaction and adjustments to each token balance may be committed to the blockchain to finalize the transfer transaction.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data,” “information,” or the like may include encompassing information such as commands, queries, files, data for storage, and the like in digital or any other form.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A distributed computing cluster and/or big data management system may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, messages, information, metadata, etc.), and/or the content itself. The content may be presented in any form or medium, and in various embodiments, the content may be delivered electronically and/or capable of being presented electronically. For example, a channel may comprise a website or device (e.g., FACEBOOK®, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, FACEBOOK® message, TWITTER® tweet and/or message, MMS, and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a magnetic tape drive, an optical disk drive, etc. The removable storage drive reads from and/or writes to a removable storage unit in a well-known manner. Removable storage unit represents a magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data files transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The computer system or any components may integrate with system integration technology such as, for example, the ALEXA system developed by AMAZON®. ALEXA is a cloud-based voice service that can help you with tasks, entertainment, general information and more. All AMAZON® ALEXA devices, such as the AMAZON ECHO®, AMAZON ECHO DOT®, AMAZON TAP®, and AMAZON FIRE® TV, have access to the ALEXA system. The ALEXA system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The ALEXA system may allow the user to access information about eligible accounts linked to an online account across all ALEXA-enabled devices.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEBSPHERE®, WEBLOGIC®, MOSS®, EDB® Postgres Plus Advanced Server® (PPAS), etc.). In various embodiments, the server may include web servers (e.g. APACHE®, IIS, GWS, SUN JAVA® SYSTEM WEB SERVER, JAVA® Virtual Machine running on LINUX® or WINDOWS®).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

As those skilled in the art will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, OS2, UNIX® OS, LINUX® OS, SOLARIS®, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and communicates a detected input from the hardware to the micro-app.

Any databases discussed herein may include relational, hierarchical, graphical, blockchain, or object-oriented structure and/or any other database configurations. The databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), MongoDB®, Redis®, Apache Cassandra®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set: e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device, or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPE”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as MICROSOFT® ACCESS® or MICROSOFT® SQL Server, ORACLE®, SYBASE®, INFORMIX® MySQL, INTERBASE®, etc., may be used to provide an Active Data Object (ADO) compliant database management system. In one embodiment, the Apache web server is used in conjunction with a Linux operating system, a MYSQL® database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT®, active server pages (ASP), common gateway interface scripts (CGI), extensible markup language (XML), dynamic HTML, cascading style sheets (CSS), AJAX (Asynchronous JAVASCRIPT® And XML), helper applications, plug-ins, and the like. A server may include a web service that receives a request from a web server, the request including a URL and an IP address (e.g., 10.0.0.2). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE® MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, APACHE® Hive, JAVA®, JAVASCRIPT®, VBScript, Macromedia Cold Fusion, COBOL, MICROSOFT® Active Server Pages, assembly, PERL, PHP, awk, Python, Visual Basic, SQL Stored Procedures, Spark, Scala, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript or the like. Cryptography and network security methods are well known in the art, and are covered in many standard texts.

In various embodiments, the software elements of the system may also be implemented using Node.js®. Node.js® may implement several modules to handle various core functionalities. For example, a package management module, such as npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIGS. 3A-4B, the process flows and screenshots depicted are merely embodiments and are not intended to limit the scope of the disclosure. For example, the steps recited in any of the method or process descriptions may be executed in any order and are not limited to the order presented.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

The disclosure and claims do not describe only a particular outcome of processing transactions using a token smart contract, but the disclosure and claims include specific rules for implementing the outcome of processing transactions using a token smart contract, and that render information into a specific format that is then used and applied to create the desired results of processing transactions using a token smart contract, as set forth in McRO, Inc. v. Bandai Namco Games America Inc. (Fed. Cir. case number 15-1080, Sep. 13, 2016). In other words, the outcome of processing transactions using a token smart contract can be performed by many different types of rules and combinations of rules, and this disclosure includes various embodiments with specific rules. While the absence of complete preemption may not guarantee that a claim is eligible, the disclosure does not sufficiently preempt the field of processing transactions using a token smart contract at all. The disclosure acts to narrow, confine, and otherwise tie down the disclosure so as not to cover the general abstract idea of just processing transactions using a token smart contract. Significantly, other systems and methods exist for processing transactions using a token smart contract, so it would be inappropriate to assert that the claimed invention preempts the field or monopolizes the basic tools of processing transactions using a token smart contract. In other words, the disclosure will not prevent others from processing transactions using a token smart contract, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include alerting a subscriber when their computer (e.g., user device 110 and/or merchant system 120) is offline. The system may include generating customized information and alerting a remote subscriber that the information can be accessed from their computer. The alerts are generated by filtering received information, building information alerts and formatting the alerts into data blocks based upon subscriber preference information. The data blocks are transmitted to the subscriber's wireless device which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface (displayed via user device 110) for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., the transfer transaction) to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of retaining control over customers during affiliate purchase transactions, using a system for co-marketing the “look and feel” of the host web page with the product-related content information of the advertising merchant's web page. The system can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, thus allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims.

Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for processing a transaction comprising:
receiving, by an issuer system in electronic communication with a token smart contract, a transfer notification comprising a user public blockchain address, a merchant public blockchain address, and a transaction amount;
retrieving, by the issuer system in electronic communication with an issuer repository, a transaction account identifier and a merchant identifier based on the user public blockchain address and the merchant public blockchain address;
adjusting, by the issuer system in electronic communication with an accounts receivable system, a transaction account balance associated with the user identifier based on the transaction amount; and
crediting, by the issuer system in electronic communication with an acquiring bank, a merchant account based on the transaction amount.

2. The method of claim 1, further comprising invoking, by the issuer system, the token smart contract to finalize the transaction, wherein the token smart contract is invoked by passing the user public blockchain address, the merchant public blockchain address, and the transaction amount.

3. The method of claim 2, wherein in response to being invoked the token smart contract is configured to adjust a user token balance associated with a user blockchain wallet, based on the user public blockchain address and the transaction amount.

4. The method of claim 3, wherein the user public blockchain address corresponding to the user blockchain wallet is associated with the transaction account identifier during a user registration process.

5. The method of claim 2, wherein in response to being invoked the token smart contract is configured to adjust a merchant token balance associated with a merchant blockchain wallet, based on the merchant public blockchain address and the transaction amount.

6. The method of claim 5, wherein the merchant public blockchain address corresponding to the merchant blockchain wallet is associated with the merchant identifier during a merchant registration process.

7. The method of claim 1, wherein the token smart contract comprises an ERC-20 compliant token.

8. A computer-based system for processing transactions, comprising:
a processor; and
a tangible, non-transitory memory configured to communicate with the processor, the tangible, non-transitory memory having instructions stored thereon that, in response to execution by the processor, cause an issuer system to perform operations comprising:
receiving, by the issuer system in electronic communication with a token smart contract, a transfer notification comprising a user public blockchain address, a merchant public blockchain address, and a transaction amount;
retrieving, by the issuer system, a transaction account identifier and a merchant identifier based on the user public blockchain address and the merchant public blockchain address;
adjusting, by the issuer system, a transaction account balance associated with the user identifier based on the transaction amount; and
crediting, by the issuer system, a merchant account based on the transaction amount.

9. The computer-based system of claim 8, further comprising invoking, by the issuer system, the token smart contract to finalize the transaction, wherein the token smart contract is invoked by passing the user public blockchain address, the merchant public blockchain address, and the transaction amount.

10. The computer-based system of claim 9, wherein in response to being invoked the token smart contract is configured to adjust a user token balance associated with a user blockchain wallet, based on the user public blockchain address and the transaction amount.

11. The computer-based system of claim 10, wherein the user public blockchain address corresponding to the user blockchain wallet is associated with the transaction account identifier during a user registration process.

12. The computer-based system of claim 9, wherein in response to being invoked the token smart contract is configured to adjust a merchant token balance associated with a merchant blockchain wallet, based on the merchant public blockchain address and the transaction amount.

13. The computer-based system of claim 12, wherein the merchant public blockchain address corresponding to the merchant blockchain wallet is associated with the merchant identifier during a merchant registration process.

14. The computer-based system of claim 8, wherein the token smart contract comprises an ERC-20 compliant token.

15. An article of manufacture including a non-transitory, tangible computer readable storage medium having instructions stored thereon that, in response to execution by a computer based system, cause the computer based system to perform operations comprising:
receiving, by the computer based system in electronic communication with a token smart contract, a transfer notification comprising a user public blockchain address, a merchant public blockchain address, and a transaction amount;
retrieving, by the computer based system, a transaction account identifier and a merchant identifier based on the user public blockchain address and the merchant public blockchain address;
adjusting, by the computer based system, a transaction account balance associated with the user identifier based on the transaction amount; and
crediting, by the computer based system, a merchant account based on the transaction amount.

16. The article of manufacture of claim 15, further comprising invoking, by the issuer system, the token smart contract to finalize the transaction, wherein the token smart contract is invoked by passing the user public blockchain address, the merchant public blockchain address, and the transaction amount.

17. The article of manufacture of claim 16, wherein in response to being invoked the token smart contract is configured to adjust a user token balance associated with a user blockchain wallet, based on the user public blockchain address and the transaction amount.

18. The article of manufacture of claim 17, wherein the user public blockchain address corresponding to the user blockchain wallet is associated with the transaction account identifier during a user registration process.

19. The article of manufacture of claim 16, wherein in response to being invoked the token smart contract is configured to adjust a merchant token balance associated with a merchant blockchain wallet, based on the merchant public blockchain address and the transaction amount.

20. The article of manufacture of claim 19, wherein the merchant public blockchain address corresponding to the merchant blockchain wallet is associated with the merchant identifier during a merchant registration process.
